(19) United States
(12) Patent Application Publication
(10) Pub. No.: US 2017/0028288 A1
(43) Pub. Date: Feb. 2, 2017

(54) ABSORPTION TOWEL

(71) Applicant: John Akers, San Fernando, CA (US)

(72) Inventor: John Akers, San Fernando, CA (US)

(21) Appl. No.: 15/208,519

(22) Filed: Jul. 12, 2016

Related U.S. Application Data
(60) Provisional application No. 62/199,114, filed on Jul. 30, 2015.

(51) Int. Cl. A63B 71/00; B62D 1/06; A47C 31/11

(52) U.S. Cl. CPC A63B 71/00; A47C 31/116; B62D 1/06

(57) ABSTRACT

An absorption towel disclosed here illustrates a towel arrangement, which will effectively protect the workout equipment from damage or stains, and protecting the user from contacting disease-causing germs. The absorption towel comprises a fabric section and a pocket section. The fabric section is configured to cover a body contact component of a workout equipment. The pocket section is defined at an upper portion of the fabric section, where the pocket section is configured to conform to an end surface the body contact component. The fabric section is configured to absorb secretions from body of a user, and to prevent the surface of the body contact component from damages due to the contact of the user's body with the body contact equipment.

### CROSS-REFERENCE TO RELATED APPLICATION

This application claims the benefit of and priority to U.S. Provisional Application Ser. No. 62/199,114 entitled “IT WORKS—WORKOUT TOWEL” filed Jul. 30, 2015, the entirety of which is hereby incorporated by reference herein for all purposes.

### FIELD OF THE INVENTION

The present invention relates generally to a towel. More specifically, the present invention is an absorption towel that is attachable to the backrest of workout equipment to absorb sweat from the users, and to protect the user from germs. Also, the absorption towel is configured to protect the equipment from damage due to impact by heavy objects.

### BACKGROUND

Currently, gym goers only use a small towel to wipe the sweat off their hands, forehead and body. The workout equipment is subjected to a lot of stress during regular cycles of workouts. This is mainly due to strenuous workouts, which are performed over the surface of such workout equipment where the entire body weight of the user is subjected to be in contact with the surface of the workout equipment. The frictional contact can cause the cushioning material inside the workout equipment to be dislocated or torn. Further, the outer surface of such workout equipment, which is made of, for example, rexine or leather, usually are prone to damage due to impact from heavy objects. Especially, seat and backrest portions are subject to wear and tear due to lack of proper covering and soiled due to frequent exposure to oil stains and sweat from the users.

In addition, these small towels in general usage cannot cover the entire backrest of the equipment and slides off the equipment easily. Due to such slippage of the towel, the user, in most cases, will not be willing to adjust the towel and continue the workout, but instead he/she will complete the workout without using the towel. This exposes the body of the user to be in contact with the bare surface of the workout equipment, which imposes the risk of contact with disease causing germs that might be on the surface of the equipment, since the equipment is used by multiple users throughout the day. Therefore, the conventional towel fails to address such issues where the towel needs to be firmly attached to the surface of the workout equipment during a workout session, in order to prevent direct contact of the skin of a user with the surface of the workout equipment.

Therefore, there is a need for an improved towel arrangement, which will effectively protect the workout equipment from damage, sweat or stains, and protecting the user from contacting disease causing germs. The towel arrangement is also desired to cover the entire backrest portion of the workout equipment as well.

### SUMMARY OF THE INVENTION

The absorption towel disclosed herein illustrates the towel arrangement, which will effectively protect the workout equipment from damage, sweat or stains, and protecting the user from contacting disease-causing germs. The absorption towel comprises a fabric section and a pocket section. The fabric section is configured to cover a body contact component of a workout equipment. The pocket section is defined at an upper portion of the fabric section, wherein the pocket section is configured to conform to an end surface the body contact component. The fabric section is configured to absorb sweat and sebum secretions from the body of a user, and to prevent the external surface of body contact component from damage.

In an embodiment, the body contact component is a backrest member or a seat member of the workout equipment. In an embodiment, the workout equipment comprises an adjustable bench, a utility bench, or a flat bench. In an embodiment, the pocket section is generally configured to absorb the sweat or similar secretions produced by the body of the user during and after workouts. In an embodiment, the fabric section is configured to frontally cover a car seat, where the secretions from the body of the user permeating through a cloth worn by the user is absorbed by the fabric section. In an embodiment, the fabric section is configured to frontally cover a car steering wheel, where the secretions from hands of the user is absorbed by the fabric section.

### BRIEF DESCRIPTION OF THE DRAWINGS

FIG. 1 exemplarily illustrates a rear perspective view of an absorption towel removably attached to a workout equipment, such as, an adjustable bench.

FIG. 2 exemplarily illustrates a side perspective view of the absorption towel removably attached to the workout equipment, such as, a utility bench.

FIG. 3 exemplarily illustrates a top perspective view of the absorption towel removably attached to the workout equipment, such as, a flat bench.

### DETAILED DESCRIPTION OF THE INVENTION

All illustrations of the drawings are for describing selected versions of the present invention and are not intended to limit the scope of the present invention. The present invention is an absorption towel 100 that hangs/stays in place on 95 percentage (%) of all new workout equipment 104 conventionally available in the market, protecting the workout equipment 104 from damage and stains and protecting the user from germs. The absorption towel 100 is one style fits most and covers the entire backrest or seat of workout equipment 104.

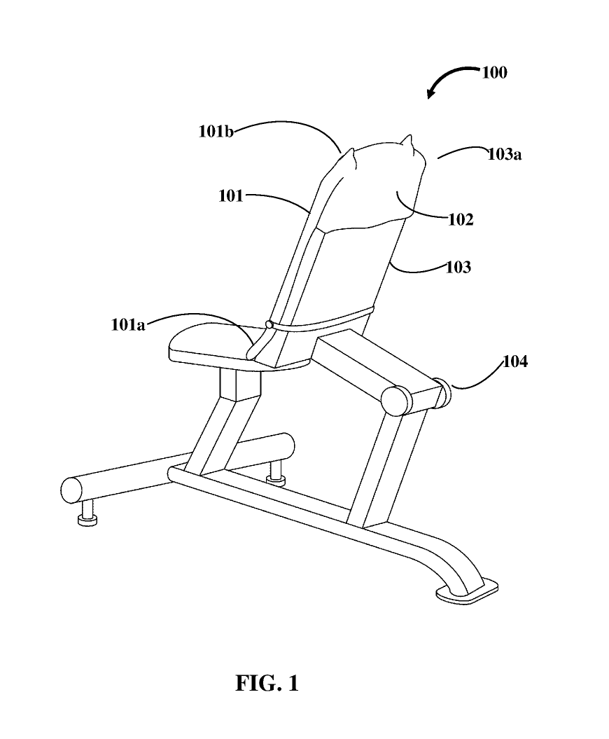

FIG. 1 exemplarily illustrates a rear perspective view of an absorption towel 100 removably attached to a workout equipment 104, such as, an adjustable bench. The absorption towel 100 comprises a fabric section 101 and a pocket section 102. The fabric section 101 is configured to cover a body contact component 103 of a workout equipment 104. The pocket section 102 is defined at an upper portion 101b of the fabric section 101, where the pocket section 102 is configured to conform to an end surface 103a the body contact component 103. The fabric section 101 is configured to absorb secretions from body of a user, and to prevent the surface of the body contact component 103 from damages due to the contact of the user's body with the body contact equipment. When the user works out, the body of the user will be in frictional contact with the surface of the body contact component 103, for example, a backrest member. This contact of the body and the backrest member can cause the material surface to be damaged due the force exerted between the both. The absorption towel 100 not only absorbs the bodily secretion, such as, sweat, but also prevents the body of the user from contacting germs that might be present on the surface of the backrest member.

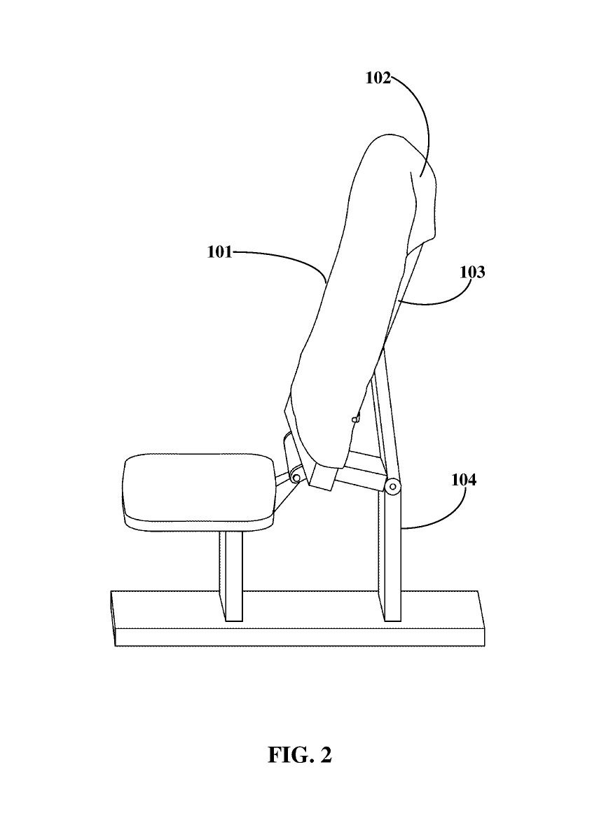

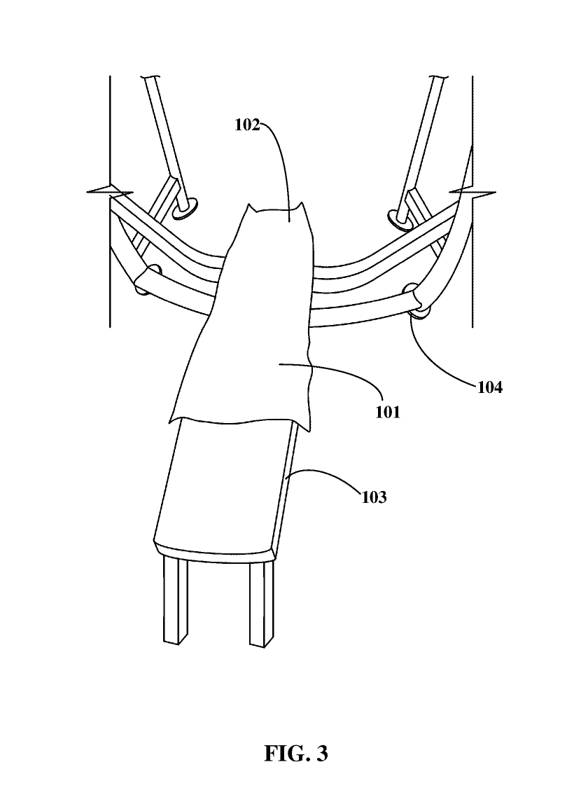

In an embodiment, the body contact component 103 is a backrest member of the workout equipment 104, as disclosed before. In an embodiment, the workout equipment 104 is either an adjustable bench as shown in FIG. 1, a utility bench, or a flat bench, as shown in FIGS. 2 and 3. In an embodiment, the pocket section 102 is generally configured to absorb the secretions generated proximal to a head of the user. In an embodiment, the fabric section 101 is configured to frontally cover a car seat, where the secretions from the body of the user permeating through a cloth worn by the user is absorbed by the fabric section 101. The dimensions of the fabric section 101 designed for car seat is, for example, approximately 53 inches long, 15 inches wide at the top, 28 inches wide at the bottom and fold over of 14 inches long. In an embodiment, the fabric section 101 is configured to frontally cover a car steering wheel, where the secretions from hands of the user is absorbed by the fabric section 101. The dimensions of the fabric section 101 designed for car steering is, for example, approximately 15 inches long, 10 inches wide at the top, 15 inches wide at the bottom, and a fold over of 8 inches length.

Referring to FIGS. 2 and 3, FIG. 2 exemplarily illustrates a side perspective view of the absorption towel 100 removably attached to the workout equipment 104, such as, a utility bench, and FIG. 3 exemplarily illustrates a top perspective view of the absorption towel 100 removably attached to the workout equipment 104, such as, a flat bench. The leather or rexine material above the surface of the backrest member is effectively protected from wear and tear due to the contact with the body of the user, and the skin of the user is completely prevented from being in direct contact on the surface of the backrest member.

Since, the absorption towel 100 is made of cloth fabric material, it is easily washable in hot water to destroy any germ occurrence, and can be reused periodically. The absorption towel 100 can be attached to a wide variety of workout equipment 104, and further, it can be used as a cover for general seating as well. The absorption towel 100, by measurements is, for example, 32 inches long and 16 inches wide, and the top section is a trapezoidal pocket section 102, which is 9.5 inches in width.

Although the invention has been explained in relation to its preferred embodiment, it is to be understood that many other possible modifications and variations can be made without departing from the spirit and scope of the invention.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1. An absorption towel comprising;
a fabric section configured to frontally cover a body contact component of a workout equipment; and
a pocket section defined at an upper portion of the fabric section, wherein the pocket section is configured to conform to an end surface the body contact component, wherein the fabric section is configured to absorb secretions from body of a user, and to prevent the surface of the body contact component from damages due to the contact of the users body with the body contact equipment.

2. The absorption towel of claim 1, wherein the body contact component is a backrest member of the workout equipment.

3. The absorption towel of claim 1, wherein the workout equipment is one of an adjustable bench, a utility bench, and a flat bench.

4. The absorption towel of claim 1, wherein the pocket section is generally configured to absorb secretions generated proximal to a head of the user.

5. The absorption towel of claim 1, wherein the fabric section is configured to frontally cover a car seat, wherein the secretions from the body of the user permeating through a cloth worn by the user is absorbed by the fabric section.

6. The absorption towel of claim 1, wherein the fabric section is configured to frontally cover a car steering wheel, wherein the secretions from hands of the user is absorbed by the fabric section.
